(19) United States
(12) Patent Application Publication
(10) Pub. No.: US 2015/0355416 A1
(43) Pub. Date: Dec. 10, 2015

(54) METHODS AND SYSTEMS FOR POLISHING OPTICAL FIBERS

(71) Applicant: CORNING OPTICAL COMMUNICATIONS LLC, Hickory, NC (US)

(72) Inventors: Anping Liu, Horseheads, NY (US); Barada Kanta Nayak, Painted Post, NY (US)

(21) Appl. No.: 14/727,976

(22) Filed: Jun. 2, 2015

Related U.S. Application Data
(60) Provisional application No. 62/008,648, filed on Jun. 6, 2014.

(51) Int. Cl. G02B 6/38; C03C 25/62; B24B 19/22

(52) U.S. Cl. CPC G02B 6/3863; B24B 19/226; C03C 25/6233

(57) ABSTRACT

A method of polishing an optical fiber that extends through a ferrule involves: (a) determining a polishing depth by measuring the distance between an end of the optical fiber and an end face of the ferrule with an interferometer; (b) performing a polishing step based on the the polishing depth to remove material from the end of the optical fiber; and (c) repeating steps (a) and (b) until the end of the optical fiber is within a predetermined distance of the end face of the ferrule. Related systems for polishing an optical fiber that extends through a ferrule are also disclosed.

### PRIORITY APPLICATION

This application claims the benefit of priority under 35 U.S.C. §119 of U.S. Provisional Application Ser. No. 62/008,648, filed on Jun. 6, 2014, the content of which is relied upon and incorporated herein by reference in its entirety.

### BACKGROUND

This disclosure relates generally to optical fibers, and more particularly to methods of polishing an optical fiber that extends through a ferrule, along with systems related to such methods.

Optical fibers are useful in a wide variety of applications, including the telecommunications industry for voice, video, and data transmissions. In a telecommunications system that uses optical fibers, there are typically many locations where fiber optic cables that carry the optical fibers connect to equipment or other fiber optic cables. To conveniently provide these connections, fiber optic connectors are often provided on the ends of fiber optic cables. The process of terminating individual optical fibers from a fiber optic cable is referred to as “connectorization.” Connectorization can be done in a factory, resulting in a “pre-connectorized” or “pre-terminated” fiber optic cable, or the field (e.g., using a “field-installable” fiber optic connector).

Regardless of where installation occurs, a fiber optic connector typically includes a ferrule with one or more bores that receive one or more optical fibers. The ferrule supports and positions the optical fiber(s) with respect to a housing of the fiber optic connector. Thus, when the housing of the fiber optic connector is mated with another connector or an adapter, an optical fiber in the ferrule is positioned in a known, fixed location relative to the housing. This allows an optical connection to be established when the optical fiber is aligned with another optical fiber provided in the mating component (the other connector or an adapter).

The bore of the ferrule in a fiber optic connector may extend from a rear of the ferrule to a front of the ferrule. With such a design, an optical fiber can be passed through the ferrule so as to extend beyond an end face at the front of the ferrule. After securing the optical fiber relative to the ferrule by using a bonding agent or the like, an optical surface (i.e., an end surface/facet intended for optical coupling) may be formed on the optical fiber. The optical surface is typically formed a precise distance from the end face of the ferrule according to very tight dimensional standards to reduce signal attenuation. For example, the final optical surface of the optical fiber may need to be within 200 nm of the end face of the ferrule.

One conventional method of forming an optical surface involves a mechanical cleaving step followed by several mechanical polishing steps. Such methods can be time-consuming and labor-intensive due to the number of polishing steps required to form the optical surface within 200 nm of the end face of the ferrule. For example, it may be necessary to begin with coarse grit when mechanically polishing and gradually switch to finer grits in subsequent polishing steps to carefully control the distance of the end of the optical fiber from the end face of the ferrule and to form an optical surface of high quality. These polishing processes can be time-consuming, labor-intensive, and use a large amount of consumables. Additionally, these processes sometimes suffer from low yields due to human error.

Various techniques for laser cleaving and polishing an optical fiber are also known. Although these techniques may help reduce or eliminate some of the mechanical polishing steps associated with forming an optical surface, there remains room for improvement.

### SUMMARY

Methods of polishing an optical fiber that extends through a ferrule are disclosed, as are systems for polishing an optical fiber that extends through a ferrule. One example of a method disclosed herein involves determining a polishing depth by measuring the distance between an end of the optical fiber and an end face of the ferrule with an interferometer. This may be referred to as a “measurement step”. The method also involves performing a polishing step based on the the polishing depth to remove material from the end of the optical fiber. The measurement step and polishing step are repeated until the end of the optical fiber is within a predetermined distance of the end face of the ferrule.

One example of a system disclosed herein includes a support configured to position the ferrule and optical fiber. The system also includes an interferometer arranged relative to support. The interferometer is configured detect deviations in directions parallel to a longitudinal axis along which the ferrule and optical fiber extend when positioned by the support. Additionally, the interferometer has a predetermined measurement range over which the interferometer can detect deviations, but the support and interferometer are movable relative to each other so that the interferometer can be used to detect deviations over a range greater than the predetermined measurement range.

Additional features and their advantages will be set forth in the detailed description which follows. Indeed, it is to be understood that both the foregoing summary and the following detailed description are merely exemplary and are intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 a perspective view of an example of a fiber optic connector;

FIG. 2 is an exploded side view the fiber optic connector of FIG. 1;

FIG. 3 is a cross-sectional view of a portion of a ferrule after an optical fiber has been inserted through and secured to the ferrule;

FIG. 4 is a schematic view of one embodiment of system for polishing an optical fiber extending through a ferrule;

FIG. 5A is an image of an exemplary interference pattern that an interferometer detects on an end of the optical fiber;

FIG. 5B is an image of an exemplary interference pattern that the interferometer detects on an end face of the ferrule;

FIG. 6 is a schematic view of another embodiment of system for polishing an optical fiber extending through a ferrule;

FIG. 7 is a schematic view of yet another embodiment of system for polishing an optical fiber extending through a ferrule; and

FIG. 8 is a schematic view of yet a further embodiment of system for polishing an optical fiber extending through a ferrule.

### DETAILED DESCRIPTION

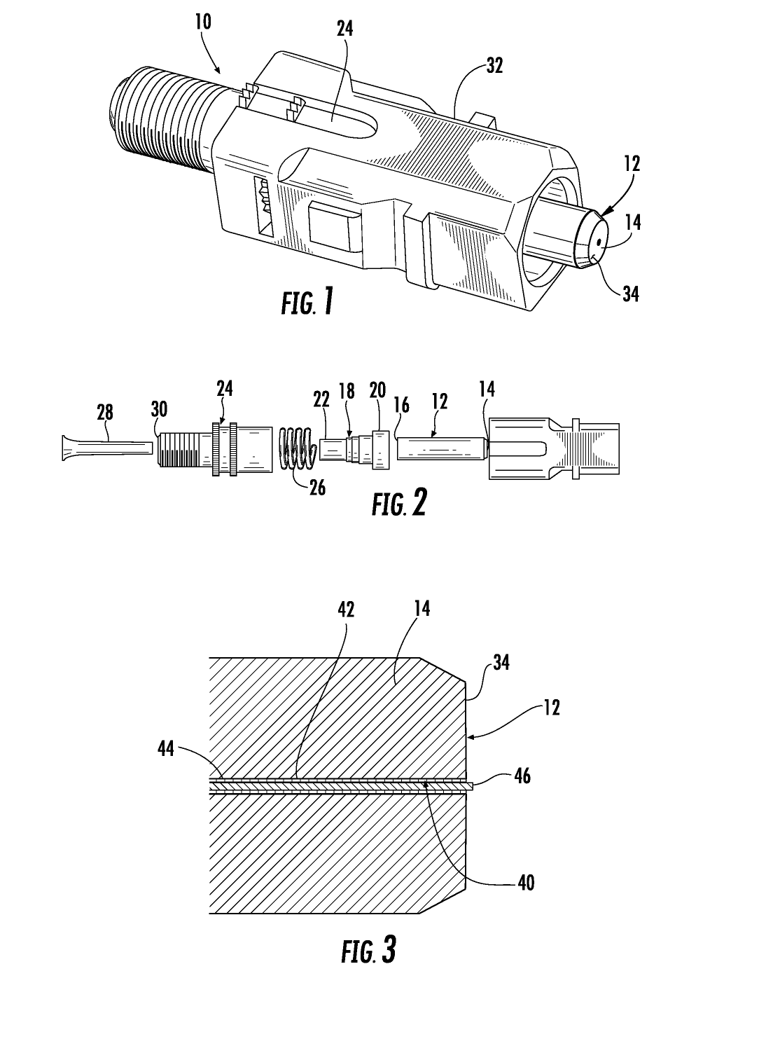

Various embodiments will be further clarified by examples in the description below. In general, the description relates to methods of polishing an optical fiber (or several optical fibers) that extends through a ferrule. The methods may be part of a cable assembly process for a fiber optic cable. That is, the methods may be part of terminating one or more optical fibers from a fiber optic cable with a fiber optic connector to form a fiber optic cable assembly. One example of a fiber optic connector (“connector”) 10 for such a fiber optic cable assembly is shown in FIG. 1. Although the connector 10 is shown in the form of a SC-type connector, the methods described below may be applicable to processes involving different connector designs. This includes ST, LC, FC, MU, and MPO-type connectors, for example, and other single-fiber or multi-fiber connector designs. A general overview of the connector 10 will be provided simply to facilitate discussion.

As shown in FIGS. 1 and 2, the connector 10 includes a ferrule 12 having a front end 14 and rear end 16, a ferrule holder 18 having opposed first and second end portions 20, 22, and a housing 24 (also referred to as an “inner housing” or “connector body”). The rear end 14 of the ferrule 12 is received in the first end portion 20 of the ferrule holder 18 while the front end 14 remains outside the ferrule holder 18. The second end portion 22 of the ferrule holder 18 is received in the housing 24. A spring 26 may be disposed around the second end portion 22 and configured to interact with walls of the housing 24 to bias the ferrule holder 18 (and ferrule 12). Additionally, a lead-in tube 28 may extend from a rear end of the housing 24 to within the second end portion 22 of the ferrule holder 18 to help guide the insertion of an optical fiber (not shown in FIGS. 1 and 2) into the ferrule 12. An outer shroud 32 (also referred to as an “outer housing”) is positioned over the assembled ferrule 12, ferrule holder 18, and housing 24, with the overall configuration being such that the front end 16 of the ferrule 12 presents an end face 34 configured to contact a mating component (e.g., another fiber optic connector; not shown).

In a manner not shown herein, a fiber optic cable providing the optical fiber also includes one or more layers of material (e.g., strength layer of aramid yarn) that may be crimped onto a rear end portion 30 of the housing 24. A crimp band may be provided for this purpose. Additionally, a strain-relieving boot may be placed over the crimped region and extend rearwardly to cover a portion of the fiber optic cable. Variations of these aspects will be appreciated by persons familiar with the design of fiber optic cable assemblies.

FIG. 3 illustrates a portion of the ferrule 12 in further detail after an optical fiber 40 has been inserted into and through a ferrule bore (also referred to as a “micro-hole”) 42. The optical fiber 40 is inserted from a rear of the ferrule bore 42 and extended until an end portion of the optical fiber exits an opening on the end face 34 of the ferrule 12. After securing the optical fiber within the ferrule bore 42 with a bonding agent 44 (also referred to as an “adhesive composition”), the end portion of the optical fiber 40 may be cleaved so that an end 46 of the optical fiber 40 is relatively close to the end face 34 (e.g., within about 50 μm), as shown in FIG. 3. Alternatively, the optical fiber 40 may be cleaved prior to insertion into the ferrule bore 42 and extended past the end face 34 in a controlled manner to limit the protruding distance (“protrusion height”) of the optical fiber 40 relative to the end face 34. Either way, there remains at least some protrusion height of the optical fiber 40 and/or at least some variance in height on a surface defined by the end 46 of the optical fiber 40 along or parallel to the axis along which the optical fiber 40 extends. The protrusion height and/or surface profile of the end 46 exceed acceptable levels such that polishing is required. Various examples of systems and methods for this processing will now be described.

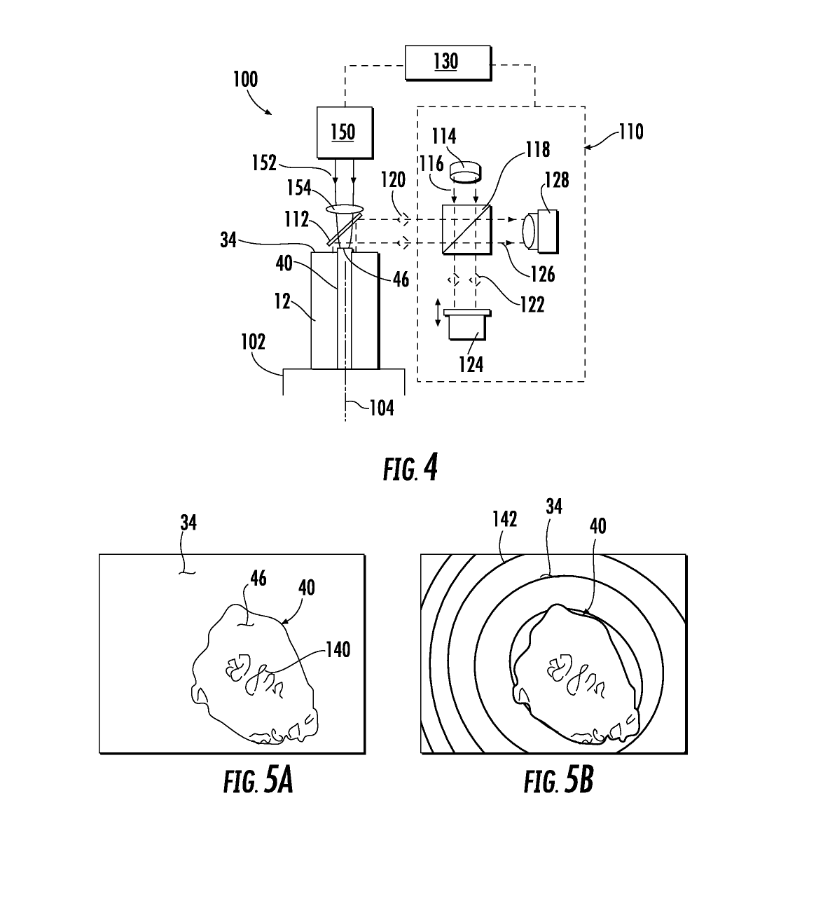

To this end, FIG. 4 schematically illustrates a system 100 including a support or fixture 102 configured to position the ferrule 12 and optical fiber 40. The support 102 may be configured to receive the ferrule 12 and optical fiber 40 as a sub-assembly of the connector 10 (FIG. 1), or may may configured to receive the connector 10 in a further-assembled or completely assembled state. For example, in some embodiments the support 102 may be designed for securely receiving and positioning the ferrule 12 and optical fiber 40 after securing the optical fiber 40 within the ferrule bore 42. In other embodiments, the support 102 may be designed for securely receiving and positioning the ferrule 12 and optical fiber 40 together with the ferrule holder 18, housing 24, outer shroud 32, etc.

The system 100 also includes an interferometer 110 arranged relative to the support 102 (and, therefore, relative to the ferrule 12 and optical fiber 40 when positioned by the support 102). The interferometer 110 is configured to detect deviations in directions parallel to a longitudinal axis 104 along which the ferrule 12 and optical fiber 40 extend. In the embodiment shown in FIG. 4, the interferometer 110 is arranged adjacent to the support 102 in a direction transverse to the longitudinal axis 104. A mirror 112 is configured to reflect light from the interferometer 110 so that the light travels in directions parallel to the longitudinal axis 104 toward the end 46 of the of the optical fiber 40 and the end face 34 of the ferrule 12. The light then reflects from the end 46 of the optical fiber 40 and/or the end face 34 of the ferrule 12 back to the mirror 112, which in turn reflects the light back to the interferometer 110. Before providing additional details about the mirror 112 and the arrangement of the interferometer 110 relative to support 102, some general principles about interferometry will be provided to facilitate discussion.

The interferometer 110 includes a light source 114 configured to emit a beam 116 toward a beam splitter 118 (e.g., a partially-reflecting mirror), which then splits the beam 116 into a sample beam 120 and a reference beam 122. The sample beam 120 is directed to toward a “surface under test” (in this case, the end 46 of the optical fiber 40 and/or the end face 34 of the ferrule 12). The reference beam 122 is directed toward a reference object 124 (e.g., a mirror). Thus, the sample beam 120 and reference beam 122 both originate from the beam 116 with the same frequency, but travel along different optical paths. The sample beam 120 and reference beam 120 are reflected back to the beam splitter 118, which then directs a combined beam 126 to an image-capturing device 128 (e.g., a camera). The combined beam 126 is basically a superposition of two light waves. Differences in lengths of the optical paths traveled by the sample beam 120 and reference beam 122 results in a phase difference and the formation of “interference fringes”. Waves that are in phase undergo constructive interference while waves that are out of phase undergo destructive interference. The interference fringes generally define an “interference pattern”.

The reference object 124 is movable to introduce known phase-shafts between the sample beam 120 and reference beam 122. Thus, a number of interference patterns at different phases may be generated. The image-capturing device 128 communicates with a processor 130 (i.e., a computer) that is configured to analyze the interference patterns in relation to know phase differences to measure deviations in directions parallel to the longitudinal axis 104. The processor 130 can use this information to map a surface profile of the surface under test. Again, as mentioned above, these general principles about interferometry are merely to facilitate discussion. Reference number 110 is intended to refer to an interferometer in general and not necessarily the specific arrangement of components within the box associated with reference number. Other arrangements based on the same general principles are possible (some additional examples will be described below).

To map the surface profile of the end 46 of the optical fiber 40, the resolution of the interferometer 110 should be at least about 10 nm (i.e., about 10 nm or less), and even more preferably at least about 1 or 2 nm. This places constraints on the wavelength of the light source 114 in the interferometer 110, as resolutions less than about 1/100^{th} of the wavelength start becoming more difficult to achieve from a technical and/or practical (e.g., cost-efficiency) standpoint. Thus, the light source 114 may have a wavelength less than about 1000 nm to provide a resolution of at least about 10 nm. Indeed, interferometers with a light source having a wavelength of 630 nm may be used in some embodiments because such interferometers are relatively common and inexpensive.

One challenge associated with using a short wavelength to provide more resolution is the limited measurement range over which the interferometer 110 can accurately detect deviations. In particular, if the difference in phases between the sample beam 120 and reference beam 122 exceeds about one half of the wavelength of the light source 114, the interference fringes may overlap or nearly overlap such that the processor 130 cannot accurately measure deviations. Thus, the measurement range of the interferometer 110 is typically a predetermined measurement range based on the wavelength of the light source 114. For example, for an interferometer having a light source with a wavelength of 630 nm, the predetermined measurement range may be about 315 nm. The protrusion height of the optical fiber 40 after being secured to the ferrule 12 is typically well beyond such a limited measurement range, at least prior to the optical fiber 40 being polished. For example, the optical fiber 40 may still extend at least about 10 μm beyond the end face 34 of the ferrule 12 after cleaving. As a result, the use of interferometers in connection with optical fibers and ferrules has typically been limited to final inspections after polishing. That is not the case for the system 100.

Generally speaking, in the system 100, the support 102 and interferometer 110 are movable relative to each other so that the interferometer 110 can be used to detect deviations over a range greater than the predetermined measurement range of the interferometer 110. This includes ranges covering protrusion heights typically associated with optical fibers prior to polishing/final processing. As a result, the interferometer 110 may be used during the polishing process to provide closed-loop feedback throughout the process, either in real-time as the optical fiber 40 is being polished or periodically between different polishing steps. The polishing can then be carefully controlled based on the feedback to meet high precision requirements for protrusion height and surface variance.

For example, one method of polishing the optical fiber 40 extending through the ferrule 12 involves determining a polishing depth by first measuring the protrusion height (i.e., the distance between the end 46 of the optical fiber 40 and the end face 34 of the ferrule 12) with the interferometer 110. This may be achieved by monitoring interference patterns with the image-capturing device 128 of the interferometer 110 at different relative positions of the interferometer 110 and the ferrule 12 or optical fiber 40. The different relative positions may be a result of moving the support 102 relative to the interferometer 110, or vice-versa (e.g., using a high-precision movable stage whose resolution is at least 1 μm). Regardless, initially the support 102 and interferometer 110 may be positioned relative to each other such that the end 46 of the optical fiber 40 is not within the predetermined measurement range/zone of the interferometer 110. No interference pattern is detected by the image-capturing device 128.

FIG. 5A illustrates an example of an interference pattern 140 appearing on the the end 46 of the optical fiber 40 after relative movement between the support 102 and interferometer 110 has occurred. When the interference pattern 140 is detected, the processor 130 stores a first position value. Thus, the first position value is associated with one of the relative positions of the support 102 and the interferometer 110. Relative movement between the support 102 and interferometer 110 continues until the interferometer 110 detects an interference pattern 142 on the end face 34 of the ferrule 12, an example of which is shown in FIG. 5B. When this interference pattern is detected, the processor 130 stores a second position value. Thus, the second position value is associated with a different relative position of the support 102 and interferometer 110. The processor 130 may then determine the difference between the first distance value and the second distance value to obtain the polishing depth.

Note that the ferrule 12 and optical fiber 40 are securely positioned by the support 102. Thus, the position of the ferrule 12 and the optical fiber 40 relative to the interferometer 110 changes by the same amount as the position of the support 102 relative to the interferometer 110 during the relative movement mentioned above. Thus, although the first distance value and second distance value are mentioned above as being associated with different relative positions of the support 102 and interferometer 110, they can be stored by the processor 130 as being being associated with different relative positions of the interferometer 110 and the ferrule 12 or optical fiber 40. It does not matter because ultimately the polishing depth is determined based on the changes in the relative positions (again, which remain consistent for the support 102, ferrule 12, and optical fiber 40). Additionally, although the preceding paragraph discusses the first position value being stored first and the second position value being stored second, in alternative embodiments this “scanning” by the interferometer 110 may be performed in the reverse order. That is, the system 100 may controlled so that interferometer 110 first detects the end face 34 of the ferrule 12 and then the end 46 of the optical fiber 40. The end result—the polishing depth—is the same.

With the polishing depth known, a polishing step may be performed based on this information to remove material from the end 46 of the optical fiber 40. For example, in the embodiment shown, the system 100 includes at least one laser 150 configured to laser process the end 46 of the optical fiber 40. The laser 150 is shown as being positioned in-line with the longitudinal axis 104 such that the mirror 112 is positioned between the laser 140 and the end 46 of the optical fiber 40. A beam 152 from the laser 150 is focused by a lens 154 passes through the mirror 112 when emitted by the laser 150 so that the beam 152 is incident on the optical fiber 40. Thus, this embodiment, the mirror 112 is a dichroic mirror that is transmissive to light from the laser 150 and reflective to light from the interferometer 110. Other arrangements involving at least one laser are possible, as will be apparent based on the description of additional examples below, as are arrangements without lasers. The latter may be case if the polishing step is performed by mechanically polishing the end 46 of the optical fiber 40 with a polishing device (e.g., a polishing pad or puck; not shown).

The polishing process may be iterative with the measuring and polishing steps mentioned above being repeated one or more times. It is not necessary for the laser 150 to remove all of the material from the optical fiber 40 necessary to form the final optical surface (“facet”) in a single polishing step. One or more “course” polishing steps may initially be performed to quickly reduce the protrusion height without damaging the end face 34 of the ferrule 12, followed by one or more “fine” polishing steps where less material is removed to more carefully control: (a) bringing the end 46 of the optical fiber 40 flush with or substantially flush with the end face 34 of the ferrule 12 (i.e., the end 46 of the optical fiber 40 being within an acceptable, predetermined distance of the end face 34 of the ferrule 12, such as within about 100 nm); and/or (b) bringing height variance in the surface profile of the end 46 of the optical fiber 40 to within acceptable levels (e.g., the end 46 of the optical fiber 40 varying in height by less than about 200 nm).

Although this may sound similar to conventional techniques, in the methods disclosed herein the polishing depth is determined during and/or between the various polishing steps so that the information is taken into account for each polishing step. For example, when one or more lasers are used, the processor 130 may adjust at least one of the following process parameters of the laser(s) based on the polishing depth: intensity, beam size, location relative to the optical fiber, exposure time, pulse duration, or polarization. Alternatively, when polishing is done manually without the use of lasers, the processor 130 may indicate to an individual an appropriate polishing device to use for a given polishing step and, if desired, provide instructions relating to the use of the polishing device for that polishing step. Embodiments are also possible where polishing is completed by a combination of laser processing steps and mechanical polishing steps (i.e., using one or more lasers for some polishing steps and mechanical polishing devices for other polishing steps, still with the polishing depth being measured between the steps). Additionally, in some embodiments, mechanical polishing may accomplished by a machine that communicates with the processor 130 rather than manually by an individual.

Regardless, the system 100 enables polishing processes to be more carefully controlled. Unlike conventional techniques, polishing steps need not be performed “blindly” according to predetermined steps. The feedback provided by the interferometer 110 and taken into account by the processor 130 enables adjustments to be made to polishing steps as needed to more efficiently and effectively form the final optical surface on the end 46 of the optical fiber 40. This, in turn, may reduce process time, lower production costs, and/or increase yields.

At some point during the polishing process, the protrusion height of the optical fiber 40 may fall within the predetermined measurement range of the interferometer 110. The polishing depth may then be determined using the capability of the interferometer 110. In other words, relative movement between the interferometer 110 and the support 102/ferrule 12/optical fiber 40 is not required. The distance between the interferometer 110 and the support 102/ferrule 12/optical fiber 40 from a previous time the polishing depth was determined may be maintained.

As can be appreciated, the system 110 enables nanometer resolution across a range more than the predetermined measurement range of the interferometer 110 (the latter typically being a sub-micron range for reasons mentioned above). Stated differently, the extent to which the support 102 and interferometer 110 are movable relative to each other define a dynamic range of the system 100. The dynamic range is much greater than the predetermined measurement range of the interferometer 110. For example, the dynamic range may be at least about 10 μm (or even at least about 20 μm), while the predetermined measurement range of the interferometer 110 may be less than about 500 nm (recall that about 315 nm is mentioned in the example above).

Another possible feature and advantage of the system 100 is that the optical path for the sample beam 120 of the interferometer 110 need not include any lenses between the beam splitter 118 and optical fiber 40 configured to focus light from the interferometer 110. As shown schematically in FIG. 4, the sample beam 120 may be a collimated beam of light that has a diameter about two or three times the optical fiber 40 so that the sample beam 120 can be exposed to the entire end 46 of the optical fiber 40 and a surrounding portion of the end face 34 of the ferrule 12. The use of a large beam avoids the need to measure at different locations across this area, thereby minimizing measurement time. Additionally, the absence of lenses that would otherwise be considered part of the interferometer 110 enables the interferometer 110 to be spaced a relatively large working distance (e.g., about 50 mm or more) from the optical fiber 40. Such an arrangement makes the end 46 of the optical fiber 40 easier to access to complete polishing steps, helps avoid damage or contamination to components of the interferometer 110 from debris formed during the polishing steps, and/or enables components like the mirror 112 to be incorporated into the system 100 if desired. The working distance may be measured in a direction transverse to the longitudinal axis 104 in some embodiments or along the longitudinal axis 104 in other embodiments, depending on the arrangement of the interferometer 110 relative to the support 102/ferrule 12/optical fiber 40.

Persons skilled in optical connectivity will appreciate additional variations and modifications of the systems and methods already described. Indeed, FIGS. 6, 7, and 8 illustrate systems 200, 300, and 400, respectively, as examples of some variations. Not all elements of the system are shown to simplify matters (e.g., a processor is not shown), as only some differences from the system 100 will be described.

In FIG. 6, the interferometer 110 is positioned in-line with (i.e., along) the longitudinal axis 104 such that a mirror to direct the sample beam 120 to the end 46 of the optical fiber 40 is not required. One or more lasers 150 direct one or more beams 152 toward the end 46 of the optical fiber 40 at an angle. The laser beams 150 may, for example, have an angle of incidence of at least about 45° with respect to the longitudinal axis 104. Although two lasers 150 with respective laser beams 152 and lenses 154 are shown, any number of lasers or laser beams may be used, and each laser beam need not originate from a different laser.

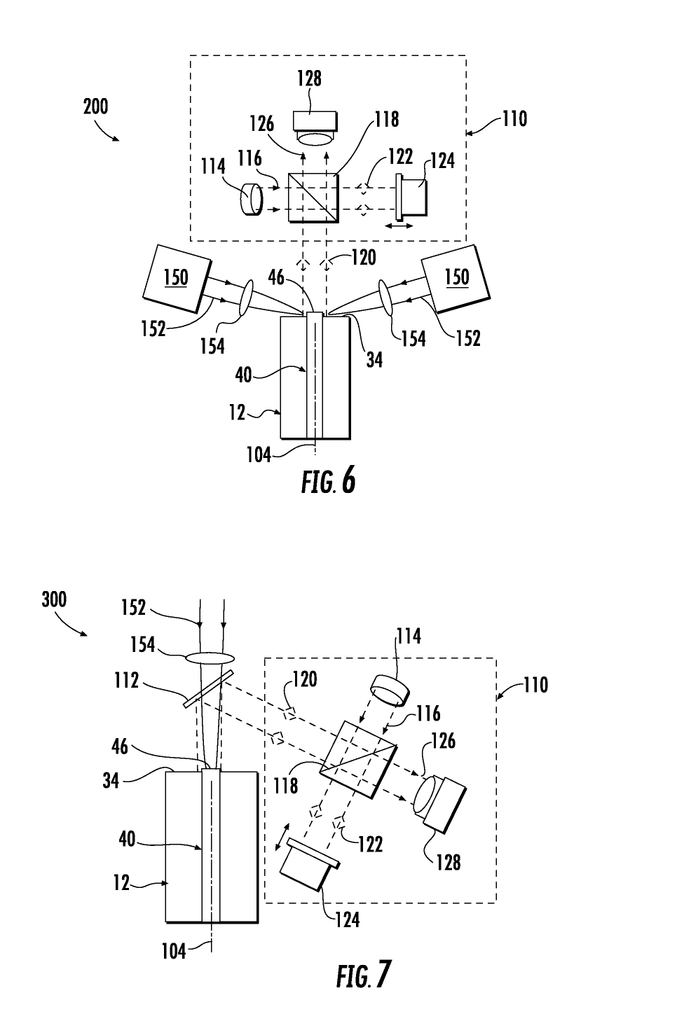

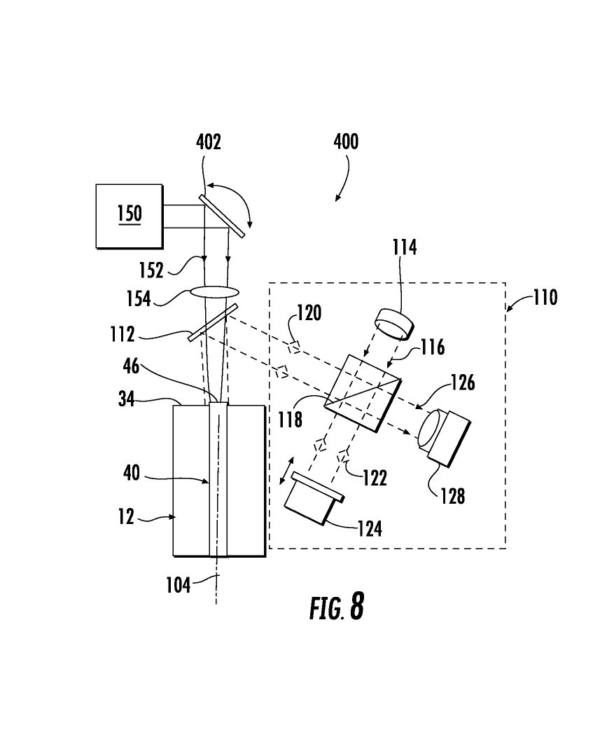

In FIG. 7, the interferometer 110 is arranged in a different manner relative to the optical fiber 40 to increase the working distance between the interferometer 110 and optical fiber 40 (i.e., components of the interferometer 110 may be spaced further from the optical fiber 40 to further reduce the potential for contamination).

FIG. 8 illustrates an arrangement similar to FIG. 7, but schematically shows how a scanning mirror 402 may be used to control the beam location on the end 46 of the optical fiber 40. The scanning mirror 402 may be controlled to rapidly move the location of the laser beam 152 so that only a very small area of the optical fiber 40 is affected in an extremely short period. This not only helps reduce the heat-affected zone and mitigate residual stress in the optical fiber 40, but also allows material removal to be more precisely controlled. For example, the amount of removal may be controlled by both laser power and scanning speed. Alternatively, for a pulsed laser, the amount of material removal may be precisely controlled by short pulse durations in combination with rapidly moving the scanning mirror 402.

Again, systems 200, 300, and 400 are merely examples of some variations of the systems and methods disclosed herein. Other variations, including the order in which the method steps are performed, will be appreciated. To this end, where a method claim below does not actually recite an order to be followed by its steps or it is not otherwise specifically stated in the claims below or description above that the steps are to be limited to a specific order, it is no way intended that any particular order be inferred.

What is claimed is:

1. A method of polishing an optical fiber that extends through a ferrule, the method comprising:
(a) determining a polishing depth by measuring the distance between an end of the optical fiber and an end face of the ferrule with an interferometer;
(b) performing a polishing step based on the the polishing depth to remove material from the end of the optical fiber;
(c) repeating steps (a) and (b) until the end of the optical fiber is within a predetermined distance of the end face of the ferrule.

2. A method according to claim 1, wherein the predetermined distance is about 100 nm.

3. A method according to claim 1, further comprising:
determining a surface profile of the end of the optical fiber, wherein steps (a) and (b) are repeated until the surface profile of the end of the optical fiber varies in height by less than about 200 nm.

4. A method according to claim 1, wherein the end of the optical fiber extends at least about 10 μm beyond the end face of the ferrule prior to determining a polishing depth for the first time such that an initial polishing depth measured by the interferometer is at least about 10 nm.

5. A method according to claim 1, wherein steps (a) and (b) are repeated at least three times.

6. A method according to claim 1, wherein determining a polishing depth for at least the first time comprises:
monitoring interference patterns with the interferometer at different relative positions of the interferometer and the ferrule or the fiber;
storing a first position value when the interferometer detects an interference pattern on the end of the optical fiber, the first position value being associated with one of the relative positions;
storing a second position value when the interferometer detects an interference pattern on the end face of the ferrule, the second position value being associated with another of the relative positions; and
determining the difference between the first distance value and second distance value to obtain the polishing depth.

7. A method according to claim 6, wherein monitoring interference patterns with the interferometer at different relative positions of the interferometer and the ferrule or the optical fiber comprises:
moving the ferrule and the optical fiber relative to the interferometer, or vice-versa; and
detecting interference patterns at least every 1 μm of movement.

8. A method according to claim 6, wherein determining a polishing depth for at least one subsequent time comprises:
maintaining the distance between the interferometer and the ferrule or the optical fiber from a previous time the polishing depth was determined.

9. A method according to claim 1, wherein the polishing step is performed at least once by mechanically polishing the end of the optical fiber with a polishing device.

10. A method according to claim 1, wherein the polishing step is performed at least once by laser processing the end of the optical fiber with at least one laser, and wherein the laser processing comprises adjusting at least one of the following process parameters of the at least one laser based on the polishing depth: intensity, beam size, location relative to the optical fiber, exposure time, pulse duration, or polarization.

11. A method according to claim 1, wherein light from the interferometer is directed to the end of the optical fiber without being focused by a lens between the interferometer and the ferrule.

12. A method according to claim 1, wherein the interferometer includes a light source that emits light with a wavelength less than about 1000 nm.

13. A method of polishing an optical fiber that extends through a ferrule, the method comprising:
(a) determining a polishing depth by measuring the distance between an end of the optical fiber and an end face of the ferrule with an interferometer, wherein a surface profile of the end of the optical fiber is also determined;
(b) performing a polishing step based on the the polishing depth to remove material from the end of the optical fiber;
(c) repeating steps (a) and (b) until the end of the optical fiber is within about 100 nm of the end face of the ferrule and until the surface profile of the end of the optical fiber varies in height by less than about 200 nm;
wherein determining a polishing depth for at least the first time comprises:
monitoring interference patterns with the interferometer at different relative positions of the interferometer and the ferrule or the fiber;
storing a first position value when the interferometer detects an interference pattern on the end of the optical fiber, the first position value being associated with one of the relative positions;
storing a second position value when the interferometer detects an interference pattern on the end face of the ferrule, the second position value being associated with another of the relative positions; and
determining the difference between the first distance value and second distance value to obtain the polishing depth; and
wherein the end of the optical fiber extends at least about 10 μm beyond the end face of the ferrule prior to determining a polishing depth for the first time such that an initial polishing depth measured by the interferometer is at least about 10 μm.

14. A system for polishing an optical fiber that extends through a ferrule, comprising:
a support configured to position the ferrule and optical fiber;
an interferometer arranged relative to support, the interferometer being configured detect deviations in directions parallel to a longitudinal axis along which the ferrule and optical fiber extend when positioned by the support;
wherein:
the interferometer has a predetermined measurement range over which the interferometer can detect deviations; and
the support and interferometer are movable relative to each other so that the interferometer can be used to detect deviations over a range greater than the predetermined measurement range.

15. A system according to claim 14, wherein:
the extent to which the support and interferometer are movable relative to each other define a dynamic range of the system;
the dynamic range is at least 10 μm; and
the predetermined measurement range of the interferometer is less than about 500 nm.

16. A system according to claim 14, further comprising:
at least one laser configured to laser process the end of the optical fiber when the ferrule and the optical fiber are positioned by the support; and
a processor configured to store position values associated with different relative positions of the support and the interferometer;
wherein the processor is configured to determine a polishing depth of the optical fiber when the ferrule and the optical fiber are positioned on the support, the polishing depth being based on a first position value associated with the relative position at which the interferometer detects an interference pattern on an end of the optical fiber and a second position value associated with the relative position at which the interferometer detects an interference pattern on an end face of the ferrule; and
wherein the processor is also configured to adjust at least one of the following process parameters of the at least one laser based on the polishing depth: intensity, beam size, location relative to the optical fiber, exposure time, pulse duration, or polarization.

17. A system according to claim 16, further comprising:
a dichroic mirror is positioned between the at least one laser and the support, the dichroic mirror being transmissive to light from the at least one laser and reflective to light from the interferometer.

18. A system according to claim 14, wherein the interferometer is spaced a working distance from the optical fiber, the working distance being greater than about 50 mm.

19. A system according to claim 14, wherein an optical path is defined between the interferometer and the support, and further wherein there are no lenses in the optical path configured to focus light from the interferometer.

20. A system according to claim 14, wherein the interferometer includes a light source that emits light with a wavelength less than about 1000 nm.
